(19) United States
(12) Patent Application Publication
(10) Pub. No.: US 2010/0074066 A1
(43) Pub. Date: Mar. 25, 2010

(54) SERVO SYSTEM OF OPTICAL DISC AND RELATED SERVO METHOD

(76) Inventors: Chi-Jui Lee, Tao-Yuan City (TW); Shih-Hao Ko, Taichung County (TW); Kuo-Jung Lan, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/236,518

(22) Filed: Sep. 24, 2008

(51) Int. Cl. G11B 7/00

(52) U.S. Cl. 369/44.32; G9B/7

(57) ABSTRACT

The present invention discloses a servo system of an optical storage device, the optical storage device includes a pick-up unit for detecting signals reflected from an optical disc to generate a plurality of detecting signals, the servo system includes: a focus error signal generating module coupled to the pick-up unit for generating a plurality of focus error signals according to the detecting signals; a focus servo control module coupled to the focus error signal generating module for generating a focus control signal according to the focus error signals; and a focus actuator coupled to the focus servo control module and the pick-up unit for controlling the pick-up unit to adjust a focus position on the optical disc according to the focus control signal.

### BACKGROUND

The present invention is related to a servo system and a servo control method of an optical storage device, and more particularly to the servo system that utilizes a plurality of focus error signals to detect layer jumping of a pick-up unit, and the servo control method thereof.

Please refer to FIG. 1. FIG. 1 is a diagram of a servo control system 10 for an optical storage device according to the related art. The servo control system 10 comprises a photo detecting device 11, a focus error generator 12, a layer detector 13, a controlling unit 14, and a focus actuator 15. The photo detecting device 11 generates a plurality of detecting signals Sₙₐ˜Sₙₕ. The number of detecting signals is depended on the design of an optical pick-up unit (OPU, not shown in FIG. 1) and the photo detecting device 11, may have 4 to 12 detecting signals. The focus error generator 12 generates a focus error signal S_{FE} according to the detecting signals Sₙₐ˜Sₙₕ. The layer detector 13 receives the focus error signal S_{FE} to generate a control signal S_{ct} to the controlling unit 14. Furthermore, the controlling unit 14 receives the focus error signal S_{FE} and the control signal S_{ct} to generate a focus control signal S_{FOO} to the focus actuator 15. The focus actuator 15 controls the OPU to adjust a focus position on an optical disc according to the focus control signal S_{FOO}.

FIG. 2 is a diagram illustrating a main beam focus error (MFE) signal, a side beam focus error (SFE) signal, and a differential astigmatism detection focus error (DAD FE) signal according to the related art. The focus error signal S_{FE}, as shown in FIG. 1, is a DAD FE signal or a MFE signal. The DAD FE is generated by combining the MFE signal and the SFE signal as shown in FIG. 2. The MFE signal is generated from the main beam area of the photo detecting device 11, while the SFE signal is generated from the side beam area of the photo detecting device 11. Therefore, it can be seen that the MFE signal comprises two S-curve signals S_{ML0}, S_{ML1}, which respectively represent the signals of the two layers L0, L1 of the optical disc. However, the SFE signal mainly comprises three S-curve signals S_{SL0}, S_{SL1}, and S_{MIDDLE}, which represent the side beam signals of the two layers L0, L1, and the fake signal between the layers L0, L1. Furthermore, the SFE signal comprises some sub-fake signal S_{fake} that occurs at both sides of the SFE signal. In addition, the DAD FE signal is obtained by combining the MFE signal and the SFE signal. Therefore, the DAD FE signal mainly comprises three S-curve signals S_{DADL0}, S_{DADL1}, and S_{MIDDLE}, in which the S-curve signals S_{DADL0}, S_{DADL1} represent the main beam signals of the two layers L0, L1, and S_{MIDDLE} represents the major fake signal between the layers L0, L1 of the optical disc. Similarly, the DAD FE signal also comprises some sub-fake signal S_{DADfake} at both sides.

Please refer to FIG. 3. FIG. 3 is a timing diagram illustrating a focus on signal S_{FOON}, the DAD FE signal, and the focus control signal S_{FOO} when the optical storage device execute “Layer Jump” according to the related art. When the optical storage device executes “Layer Jump” from a current layer to a target layer of an optical disc, layer detector 13 receives the focus error signal S_{FE} to generate the focus on signal S_{FOON} to change from a high voltage level into a low voltage level at time tₐ, then the controlling unit 14 enters the layer-jump open loop situation at time tₐ, which means that the optical pick-up unit will start to jump from the current layer to the target layer. The layer detector 13 compares the focus error signal S_{FE} with a high reference voltage Vₜₐ and a low reference voltage V_{tb} for detecting the position of the photo detecting device 11. At time t_{b}, the layer detector 13 detects that the focus error signal S_{FE} is lower than the high reference voltage Vₜₐ once more, and the layer detector 13 outputs the control signal S_{ct} for the controlling unit 14 to return the focus control signal S_{FOO} to an average voltage level at time t_{b} for informing the focus actuator 15 to turn off the pulling force for lens of the OPU. Meanwhile, the focus point keeps moving from the low recording layer to the high recording layer. At time t_{c}, the layer detector 13 detects that the focus error signal S_{FE} is lower than the low reference voltage V_{tb}, which is caused by the fake signal S_{middle} between the layer L0, L1, so the layer detector 13 erroneously outputs the control signal S_{ct} for the control unit 14 to change the focus control signal S_{FOO} to a low voltage level at time t_{c} to inform the focus actuator 15 to provide a pushing force for the lens of the OPU, wherein the pushing force is in an opposite direction to the pulling force. The focus point then slows down. Again, at time t_{d}, the layer detector 13 detects that the focus error signal S_{FE} is higher than the low reference voltage V_{tb}, which is caused by the fake signal S_{middle} between the layer L0, L1, so the layer detector 13 erroneously outputs the control signal S_{ct} for the control unit 14 to change the focus control signal S_{FOO} to return to the average voltage level for informing the focus actuator 15 to turn off the pushing force for the lens of the OPU. As a result of the fake signal S_{middle}, the OPU focuses at the wrong position of the dual-layer optical disc. The correct position of the target layer should be located at the point Nₐ as shown in FIG. 3, and the dashed line on the focus error signal S_{FE} represents the correct curve tracking of the jumping of the focus point.

One related art method for solving the above mentioned problem is to widen the range between the low reference voltage Vₜₐ and the high reference voltage V_{tb} within the layer detector 13. However, it is hard to determine a predetermined range of the low reference voltage Vₜₐ and the high reference voltage V_{tb} that is appropriate for all variety of dual-layer optical discs.

Another related art method for solving the above mentioned problem is simply to utilize the main beam focus error (MFE) signal as the focus error signal S_{FE}. However, as known by those skilled in this art, the MFE signal will always be seriously affected by the problem of tracking error coupling when the photo detecting device 11 is in the tracking off situation.

### SUMMARY OF THE INVENTION

Therefore, one of the objectives of the present invention is to provide a servo system that utilizes a plurality of focus error signals to detect layer jumping of a pick-up unit and a method thereof.

According to an embodiment of the present invention, a servo system of an optical storage device is provided. The optical storage device comprises an optical pick-up unit for detecting signals reflected from an optical disc to generate a plurality of detecting signals, the servo system comprising a focus error signal generating module, a focus servo control module, and a focus actuator. The focus error signal generating module is coupled to the optical pick-up unit for generating a plurality of focus error signals according to the detecting signals; the focus servo control module is coupled to the focus error signal generating module for receiving focus error signals and generating a focus control signal according to the focus error signals; and the focus actuator is coupled to the focus servo control module and the optical pick-up unit for controlling the pick-up unit to adjusting a focus position on the optical disc according to the focus control signal.

According to a second embodiment of the present invention, a servo system of an optical storage device is provided. The optical storage device comprises a pick-up unit for detecting signals reflected from an optical disc to generate a plurality of detecting signals, the servo system comprises a focus error signal generating module, a layer detector, a control unit, a layer detection controller, and a focus actuator. The focus error signal generating module is coupled to the pick-up unit for generating a focus error signal according to the detecting signals; the layer detector is coupled to the focus error signal generating module for detecting a layer of the optical disc and generating a control signal according to the focus error signal; the control unit is coupled to the layer detector and the focus error signal generating module for receiving the focus error signal and generating a focus control signal according to one of the focus error signal and the control signal; the layer detection controller is coupled to the layer detector for stopping the layer detector from outputting the control signal to the control unit for a predetermined period of time during a layer jump detection; and the focus actuator is coupled to the control unit and the pick-up unit for controlling the pick-up unit to adjust a focus position on the optical disc according to the focus control signal.

According to a third embodiment of the present invention, a servo controlling method of an optical storage device is provided. The optical storage device comprises a pick-up unit for detecting signals reflected from an optical disc to generate a plurality of detecting signals, the servo controlling method comprising the steps of: generating a plurality of focus error signals according to the detecting signals; generating a focus control signal according to the focus error signals; and controlling the pick-up unit to adjust a focus position on the optical disc according to the focus control signal.

According to a fourth embodiment of the present invention, a servo controlling method of an optical storage device is provided. The optical storage device comprises a pick-up unit for detecting signals reflected from an optical disc to generate a plurality of detecting signals, the servo controlling method comprising the steps of: generating a focus error signal according to the detecting signals; detecting a layer of the optical disc and generating a control signal according to the focus error signal; providing a control unit to receive the focus error signal and generating a focus control signal according to one of the focus error signal and the control signal; utilizing a layer detection controller to stop the layer detector from outputting the control signal to the control unit for a predetermined period of time during a layer jump detection; and controlling the pick-up unit to adjust a focus position on the optical disc according to the focus control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a servo control system for an optical storage device according to the related art.

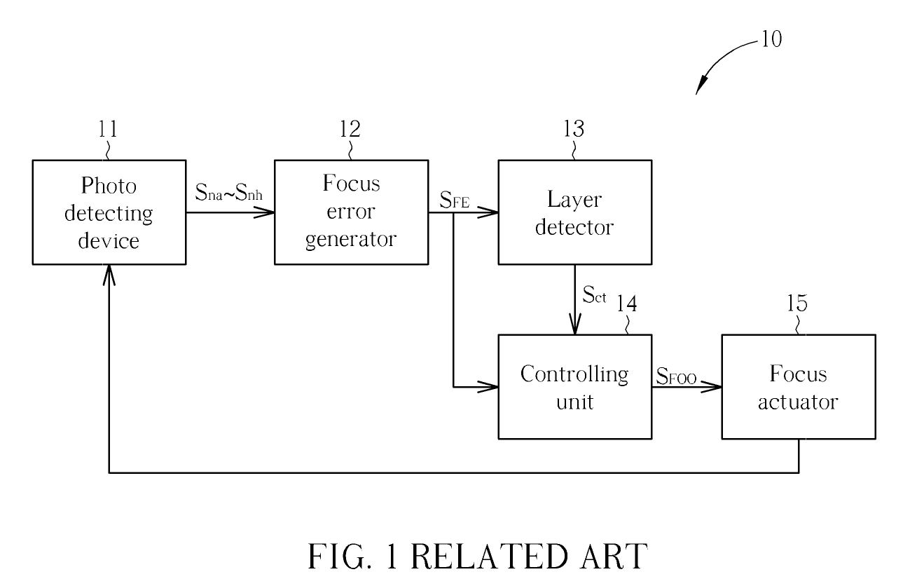

FIG. 2 is a diagram illustrating a main beam focus error (MFE) signal, a side beam focus error (SFE) signal, and a differential astigmatism detection focus error (DAD FE) signal of the related art.

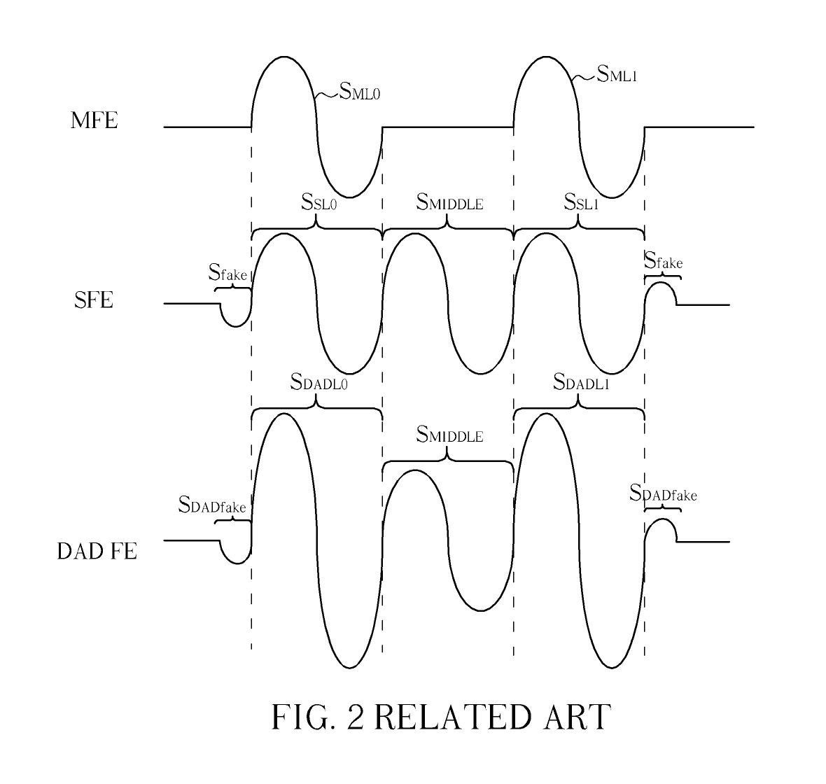

FIG. 3 is a timing diagram illustrating a focus on signal S_{FOON}, the DAD FE signal, and a focus control signal S_{FOO} when the optical storage device execute “Layer Jump” according to the related art.

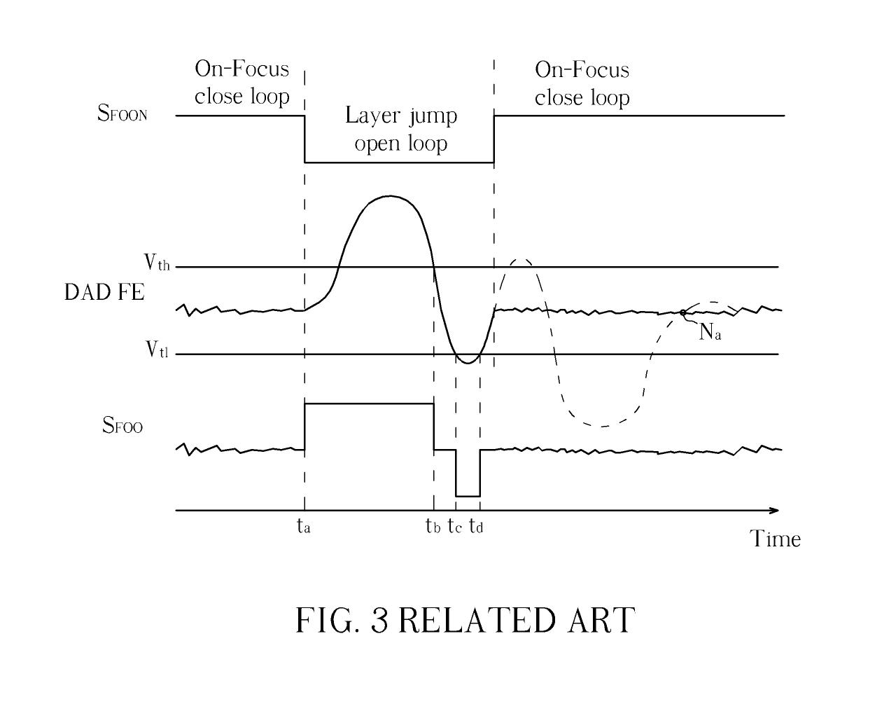

FIG. 4 is a diagram illustrating a servo system of an optical storage device according to a first embodiment of the present invention.

FIG. 5 is a timing diagram illustrating a focus on signal FOON, the DADFE signal, the focus control signal FOO, and the MFE signal of the servo system as shown in FIG. 4.

FIG. 6 is a diagram illustrating the servo system of the optical storage device according to a second embodiment of the present invention.

FIG. 7 is a timing diagram illustrating a focus on signal FOON, the focus error signal FE, and the focus control signal FOO of the servo system as shown in FIG. 6.

FIG. 8 is a diagram illustrating the servo system of the optical storage device according to a third embodiment of the present invention.

FIG. 9 is a timing diagram illustrating a focus on signal FOON, the DADFE signal, and the focus control signal FOO of the servo system as shown in FIG. 8.

FIG. 10 is a diagram illustrating a servo controlling method of the optical storage device according to a fourth embodiment of the present invention.

FIG. 11 is a diagram illustrating the servo controlling method of the optical storage device according to a fifth embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

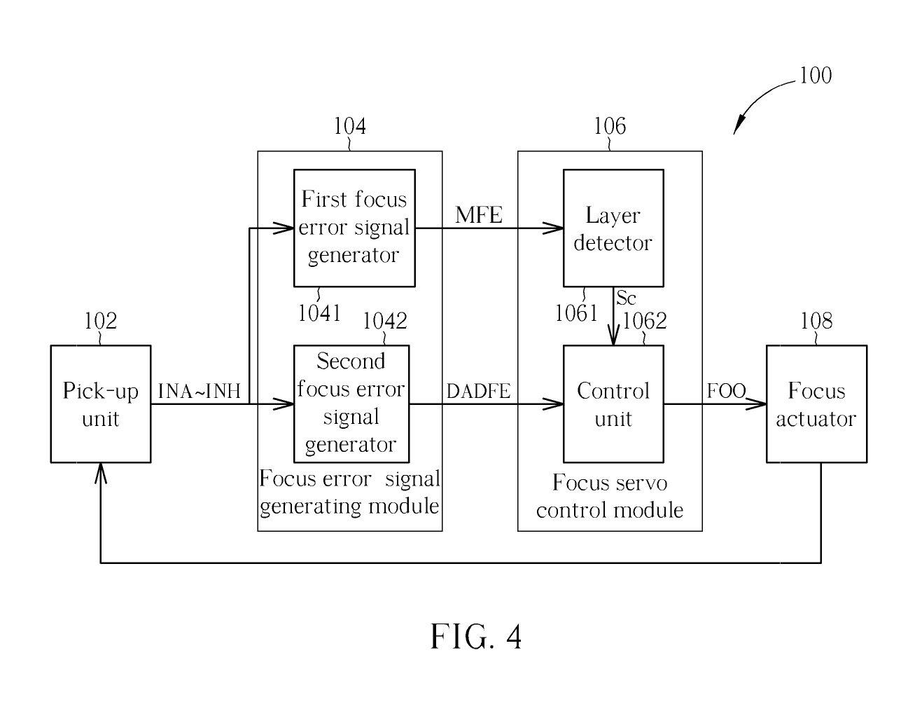

Please refer to FIG. 4. FIG. 4 is a diagram illustrating a servo system 100 of an optical storage device according to a first embodiment of the present invention, the optical storage device comprises a pick-up unit 102 for detecting signals reflected from an optical disc to generate a plurality of detecting signals INA˜INH, the servo system 100 comprises a focus error signal generating module 104, a focus servo control module 106, and a focus actuator 108. The focus error signal generating module 104 is coupled to the pick-up unit 102 for generating a plurality of focus error signals, wherein the focus error signals comprise a main beam focus error (MFE) signal and a differential astigmatism detection focus error (DADFE) signal; the focus servo control module 106 is coupled to the focus error signal generating module 104 for generating a focus control signal FOO according to the focus error signals; and the focus actuator 108 is coupled to the focus servo control module 106 and the pick-up unit 102, for controlling the pick-up unit 102 to adjust a focus position on the optical disc according to the focus control signal FOO. Furthermore, the focus servo control module 106 comprises a layer detector 1061, coupled to the focus error signal generating module 104 for receiving the main beam focus error (MFE) generated from the focus error signal generating module 104 and detecting a recording layer of the optical disc according to the main beam focus error (MFE) to generate a control signal S_{c}; and a control unit 1062, coupled to the focus error signal generating module 104 for receiving the differential astigmatism detection focus error (DADFE) generated from the focus error signal generating module and generating the focus control signal FOO according to one of the MFE signal and the DADFE signal. According to the first embodiment of the present invention, the focus error signal generating module 104 further comprises a first focus error signal generator 1041 for generating the MFE signal according to the detecting signals INA˜IND; a second focus error signal generator 1042 for generating the MFE signal or the DADFE signal according to the detecting signals INA˜INH.

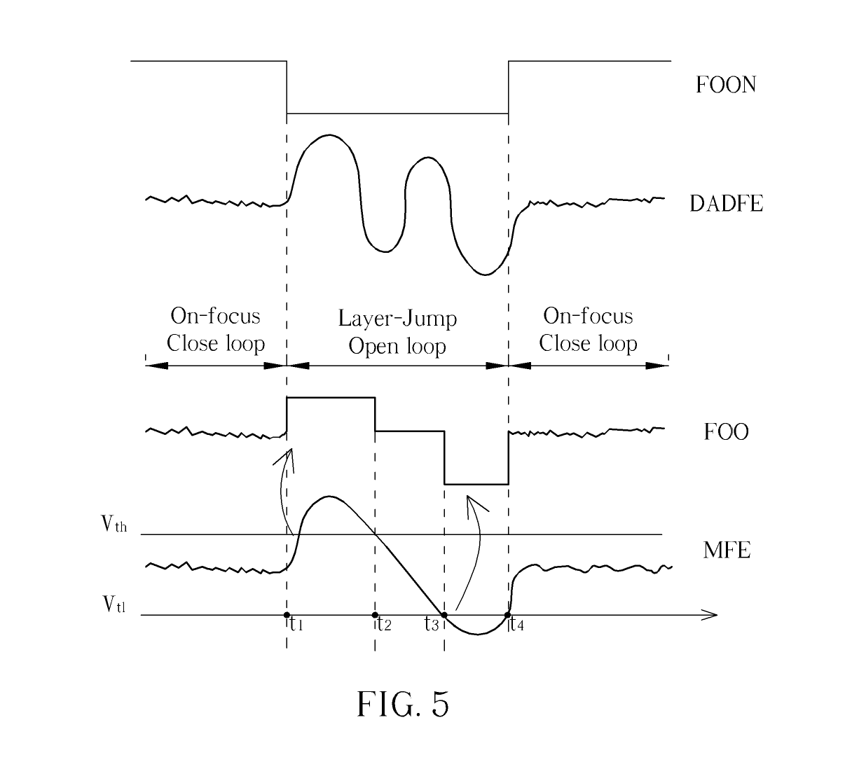

Please refer to FIG. 5. FIG. 5 is a timing diagram illustrating a focus on signal FOON, the DADFE signal, the focus control signal FOO, and the MFE signal of the servo system 100 as shown in FIG. 4. In order to describe the spirit of the present invention in more clearly, the pick-up unit 102 of the servo system 100 of the optical storage device is focused on a low recording layer of a dual-layer optical disc initially, i.e. the on-focus close loop time interval that is before the time t₁ as shown in FIG. 5. When the servo system 100 of the optical storage device receives a jump layer signal to trigger the focus on signal FOON to change from a high voltage level into a low voltage level at time t₁, the servo system 100 of the optical storage device will enter the layer-jump open loop situation at time t₁, which means that the pick-up unit 102 will start to jump from the low recording layer to a high recording layer of the dual-layer optical disc at time t₁. The first focus error signal generator 1041 generates the MFE signal to the layer detector 1061 after time t₁, wherein the MFE signal is an S-curve signal as shown in FIG. 5. Meanwhile, the second focus error signal generator 1042 also generates the MFE signal to the control unit 1062. Furthermore, the focus control signal FOO will change to a high voltage level at time t₁ to inform the focus actuator 108 to provide a pulling force for the pick-up unit 102. Then, the layer detector 1061 compares the MFE signal with a high reference voltage Vₜₕ and a low reference voltage Vₜₗ for detecting the position of the pick-up unit 102. At time t₂, the layer detector 1061 detects that the MFE signal is lower than the high reference voltage Vₜₕ once more, and the layer detector 1061 outputs the control signal S_{c} for the control unit 1062 to return the focus control signal FOO to an average voltage level at time t₂ to inform the focus actuator 108 to turn off the pulling force for the pick-up unit 102. Meanwhile, the pick-up unit 102 keeps moving from the low recording layer to the high recording layer. At time t₃, the layer detector 1061 detects that the MFE signal is lower than the low reference voltage Vₜₗ, the layer detector 1061 outputs the control signal S_{c} for the control unit 1062 to change the focus control signal FOO to a low voltage level at time t₂ for informing the focus actuator 108 to provide a pushing force for the pick-up unit 102, wherein the pushing force is in an opposite direction from the pulling force. The pick-up unit 102 then slows down. At time t₄, the layer detector 1061 detects that the MFE signal is higher than the low reference voltage Vₜₗ again, the layer detector 1061 outputs the control signal S_{c} for the control unit 1062 to change the focus control signal FOO to return to the average voltage level to inform the focus actuator 108 to turn off the pushing force for the pick-up unit 102. According to the appropriate setting of the high reference voltage Vₜₕ and the low reference voltage Vₜₗ, the pick-up unit 102 can be perfectly located at the focusing area of the high recording layer of the dual-layer optical disc as shown in FIG. 5. After time t₄, the focus on signal FOON changes from the low voltage level into the high voltage level to return the servo system 100 of the optical storage device to enter the on-focus close loop situation once more.

After reading the disclosure of the first embodiment of the present invention, those skilled in this art will readily know that the servo system 100, which generates the main beam focus error (MFE) signal and the differential astigmatism detection focus error (DADFE) signal, is capable of retaining the advantage of restraining tracking error coupling upon the DADFE signal, but can also overcome the problem of fake signals generated by the DADFE signal.

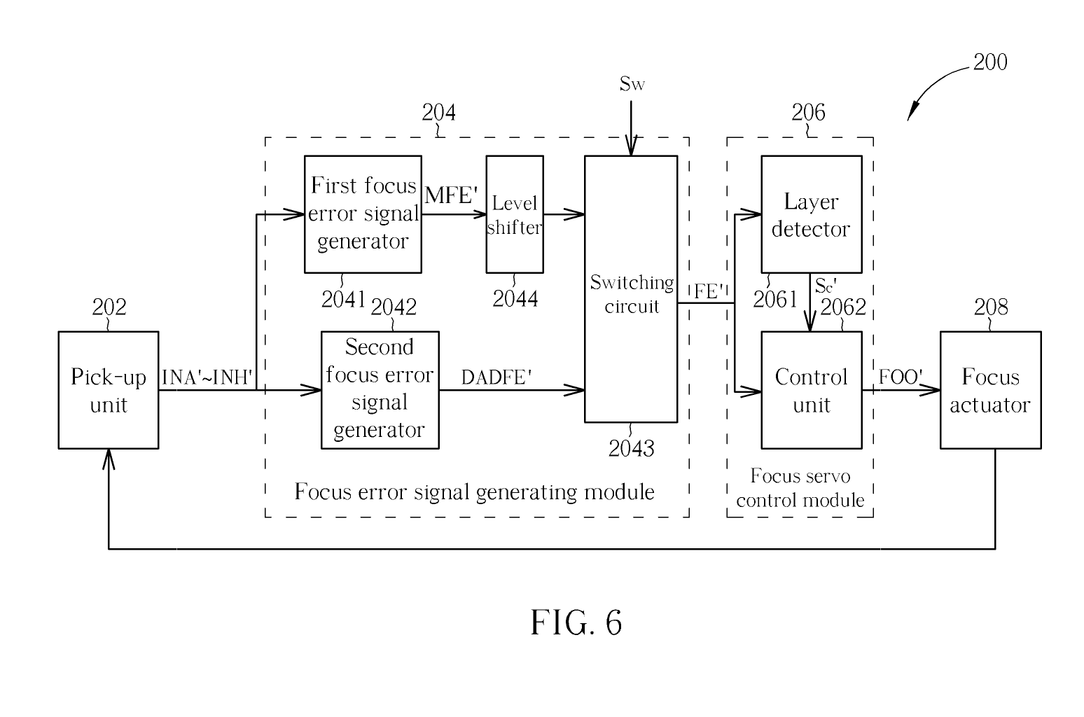

Please refer to FIG. 6. FIG. 6 is a diagram illustrating a servo system 200 of an optical storage device according to a second embodiment of the present invention. The optical storage device comprises a pick-up unit 202 for detecting signals reflected from an optical disc to generate a plurality of detecting signals INA′˜INH′, the servo system 200 comprises a focus error signal generating module 204, a focus servo control module 206, and a focus actuator 208. The focus error signal generating module 204 coupled to the pick-up unit 202 for generating a focus error signal FE′. Furthermore, according to the second embodiment of the present invention, the focus error signal generating module 204 further comprises a first focus error signal generator 2041, a second focus error signal generator 2042, and a switching circuit 2043. The first focus error signal generator 2041 generates the MFE′ signal according to the detecting signals INA′˜IND′; the second focus error signal generator 2042 generates the DADFE′ signal according to the detecting signals INA′˜INH′; and the switching circuit 2043 is coupled to the first focus error signal generator 2041 and the second focus error signal generator 2042 for selectively outputting the MFE′ signal or the DADFE′ signal to become the focus error signal FE′ for the focus servo control module 206. The focus servo control module 206 is coupled to the focus error signal generating module 204 for generating a focus control signal FOO′ according to the focus error signal FE′; and the focus actuator 208 is coupled to the focus servo control module 206 and the pick-up unit 202 for controlling the pick-up unit 202 to adjust a focus position on the optical disc according to the focus control signal FOO′. Furthermore, the focus servo control module 206 comprises a layer detector 2061 and a control unit 2062 coupled to the focus error signal generating module 204 for receiving the focus error signal FE′. In other words, the layer detector 2061 receives the MFE′ signal of the focus error signal FE′ generated from the focus error signal generating module 204 to detect a recording layer of the optical disc and to generate a control signal S_{c}′; and the control unit 2062 receives the DADFE′ signal of the focus error signal FE′ and the control signal S_{c}′ for generating the focus control signal FOO′ to the focus actuator 208. The focus error signal generating module 204 further comprises a level shifter 2044 coupled to at least one of the first focus error signal generator 2041 and the second focus error signal generator 2042 for adjusting a voltage level of at least one of the MFE′ signal and the DADFE′ signal when the switching circuit 2043 switches between the MFE′ signal and the DADFE′ signal. For brevity, the switching circuit 2043 is coupled to the first focus error signal generator 2041 in this embodiment, however those skilled in this art can easily modify the embodiment for coupling the switching circuit 2043 to the second focus error signal generator 2042 after reading the disclosure of the present invention. Furthermore, the switching circuit 2043 of this embodiment is implemented by a de-multiplexer DMUX, which is controlled by a switching signal S_{w}, as shown in FIG. 6, but this is not a limitation of the present invention.

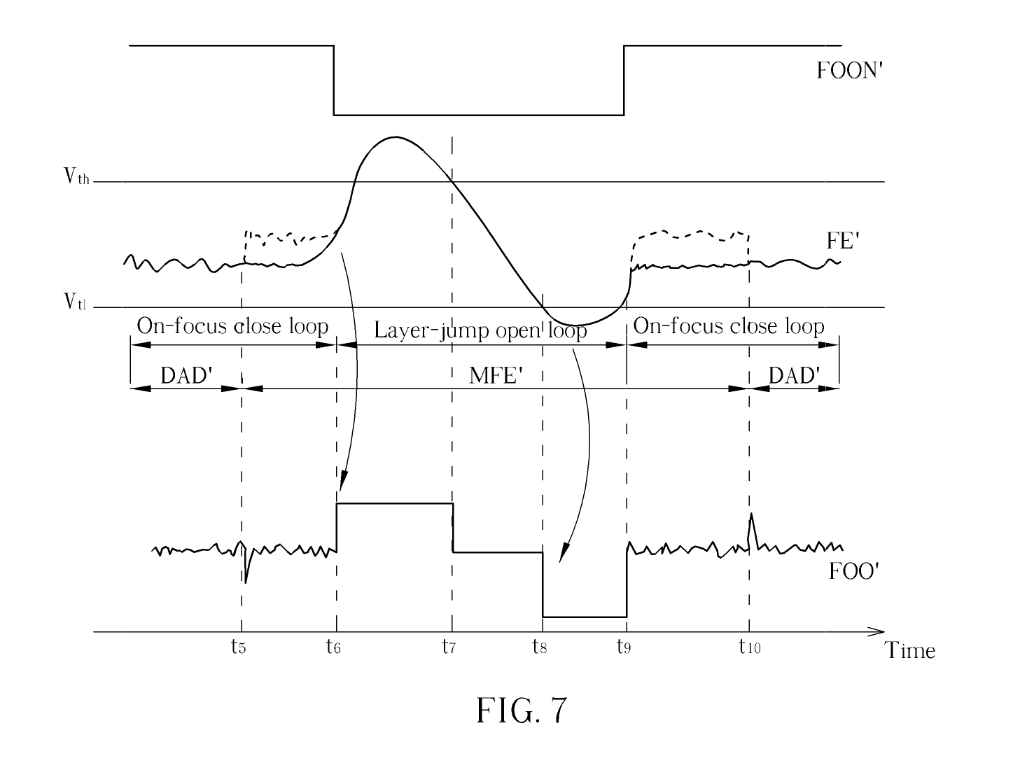

Please refer to FIG. 7. FIG. 7 is a timing diagram illustrating a focus on signal FOON′, the focus error signal FE′, and the focus control signal FOO′ of the servo system 200 as shown in FIG. 6. Similar to the first embodiment, the pick-up unit 202 of the servo system 200 of the optical storage device is focused on a low recording layer of a dual-layer optical disc initially, i.e., the on-focus close loop time interval that lies before the time t₅ as shown in FIG. 7. When the pick-up unit 202 of the servo system 200 is ready to jump from the low recording layer to a high recording layer of the dual-layer optical disc, the switching signal S_{w} controls the switching circuit 2043 to switch the focus error signal FE′ from the DADFE′ signal into the MFE signal at time t₅. As the DC level of the DADFE′ signal is different from the DC level of the MFE′ signal, there is a level jumping to the focus error signal FE′ at time t₅. According to the embodiment of the present invention, a level calibrating mechanism is used to calibrate the level of the DADFE′ signal into the MFE′ signal until both of the DADFE′ signal and the MFE′ signal have the same level before time t₅. However, in this embodiment, the level shifter 2044 is utilized for shifting the level of the MFE′ signal into the level of the DADFE′ signal after the time t₅. Accordingly, the dashed line 2041a represents the voltage level of the MFE′ signal without passing the level shifter 2044. Therefore, the focus error signal FE′ can remain at the same level after the time t₅ as shown in FIG. 7.

Then, when the servo system 200 of the optical storage device receives a jump layer signal to trigger the focus on signal FOON′ to change from a high voltage level into a low voltage level at time t₆, the servo system 200 of the optical storage device will enter the layer-jump open loop situation at time t₆, which means that the pick-up unit 202 will start to jump from the low recording layer to a high recording layer of the dual-layer optical disc at time t₆. The focus error signal FE′ (i.e., the MFE signal) generated by the first focus error signal generator 2041 is transmitted to the layer detector 2061 after time t₅, wherein focus error signal FE′ is an S-curve signal as shown in FIG. 7. Meanwhile, the focus error signal FE′ (i.e. the MFE′ signal) is also transmitted to the control unit 2062. Furthermore, the focus control signal FOO′ will change to a high voltage level at time t₆ to inform the focus actuator 208 to provide a pulling force for the pick-up unit 202. Then, the layer detector 2061 compares the focus error signal FE′ with a high reference voltage Vₜₕ′ and a low reference voltage Vₜ₁′ for detecting the position of the pick-up unit 202. At time t₇, the layer detector 2061 detects that the focus error signal FE′ is lower than the high reference voltage Vₜₕ′ again, and the layer detector 2061 outputs the control signal S_{c}′ for the control unit 2062 to return the focus control signal FOO′ to an average voltage level at time t₇ for informing the focus actuator 208 to turn off the pulling force for the pick-up unit 202. Meanwhile, the pick-up unit 202 keeps moving from the low recording layer to the high recording layer. Similar to the first embodiment, at time t₄, the layer detector 2061 detects that the focus error signal FE′ is lower than the low reference voltage Vₜₗ′, so the layer detector 2061 outputs the control signal S_{c}′ for the control unit 2062 to change the focus control signal FOO′ to a low voltage level at time t₈ for informing the focus actuator 208 to provide a pushing force for the pick-up unit 202, wherein the pushing force is in an opposite direction from the pulling force. The pick-up unit 202 then slows down. At time t₉, the layer detector 2061 detects that the focus error signal FE′ is higher than the low reference voltage Vₜₗ′ again, the layer detector 2061 outputs the control signal S_{c}′ for the control unit 2062 to change the focus control signal FOO′ to return to the average voltage level for informing the focus actuator 208 to turn off the pushing force for the pick-up unit 202. According to the appropriate setting of the high reference voltage Vₜₕ′ and the low reference voltage Vₜₗ′, the pick-up unit 202 can be perfectly located at the focusing area of the high recording layer of the dual-layer optical disc as shown in FIG. 4. After time t₉, the focus on signal FOON′ changes from the low voltage level into the high voltage level to return the servo system 200 of the optical storage device to the on-focus close loop situation once more. Then, the switching circuit 2043 switches the focus error signal FE′ from the MFE′ signal back to the DADFE′ signal at time t₁₀. Similarly, it can be seen that the dashed line 2041b represents the level of the MFE′ signal, and the level shifter 2044 shifts the level of the MFE′ signal to be consistent with the level of the DADFE′ signal. Accordingly, the focus control signal FOO′ can remain at the same level without any impulse signal being generated when the switching circuit 2043 is switching at time t₅ and t₁₀.

Similar to the first embodiment, after reading the disclosure of the first embodiment of the present invention, those skilled in this art will readily know that the servo system 200, which generates the main beam focus error (MFE′) signal and the differential astigmatism detection focus error (DADFE′) signal, is capable of retaining the advantage of restraining tracking error coupling upon the DADFE′ signal, but can also overcome the problem of fake signals generated by the DADFE′ signal.

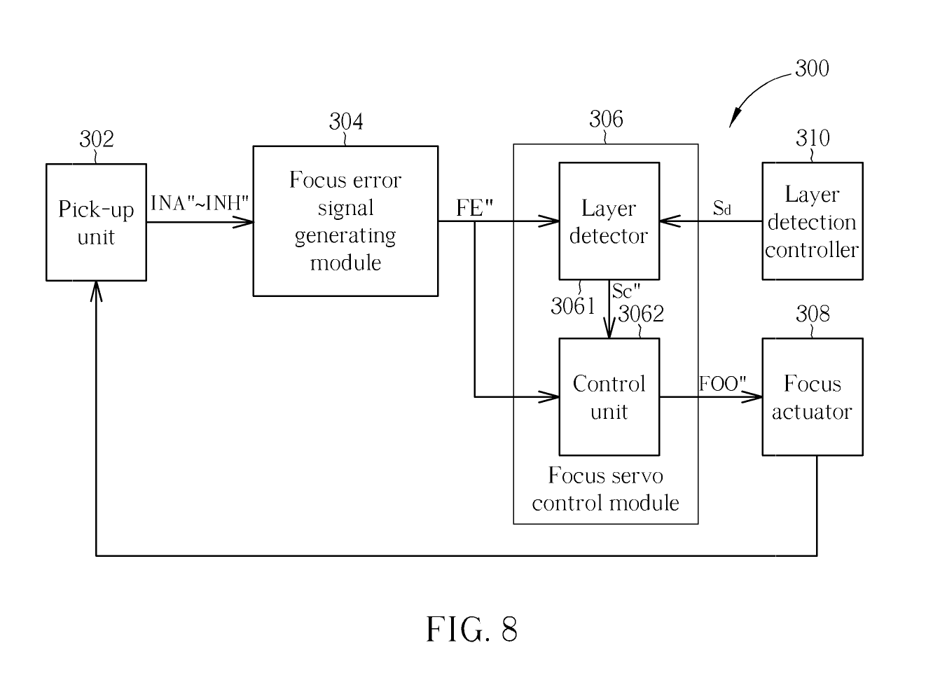

Please refer to FIG. 8. FIG. 8 is a diagram illustrating a servo system 300 of an optical storage device according to a third embodiment of the present invention. The optical storage device comprises a pick-up unit 302 for detecting signals reflected from an optical disc to generate a plurality of detecting signals INA″˜INH″, the servo system 300 comprises a focus error signal generating module 304, a focus servo control module 306, a focus actuator 308, and a layer detection controller 310. The focus error signal generating module 304 is coupled to the pick-up unit 302 for generating a plurality of focus error signals, wherein the focus error signals comprise a main beam focus error (MFE″) signal and a differential astigmatism detection focus error (DADFE″) signal; the focus servo control module 306 is coupled to the focus error signal generating module 304 for generating a focus control signal FOO″ according to the focus error signals; and the focus actuator 308 is coupled to the focus servo control module 306 and the pick-up unit 302 for controlling the pick-up unit 302 to adjust a focus position on the optical disc according to the focus control signal FOO″. Furthermore, the focus servo control module 306 comprises a layer detector 3061, coupled to the focus error signal generating module 304 for receiving a focus error signal FE generated from the focus error signal generating module 304 and detecting a recording layer of the optical disc according to the focus error signal FE″ to generate a control signal S_{c}″, in which the focus error signal FE″ is the DADFE″ signal; and a control unit 3062, coupled to the focus error signal generating module 304 for receiving the focus error signal FE″ generated from the focus error signal generating module 304 and generating the focus control signal FOO″ according to one of the focus error signals FE″. The layer detection controller 310 is coupled to the layer detector 3061 for stopping the layer detector 3061 from outputting the control signal S_{c}″ to the control unit 3062 for a predetermined period t_{disable} of time during a layer jump detection.

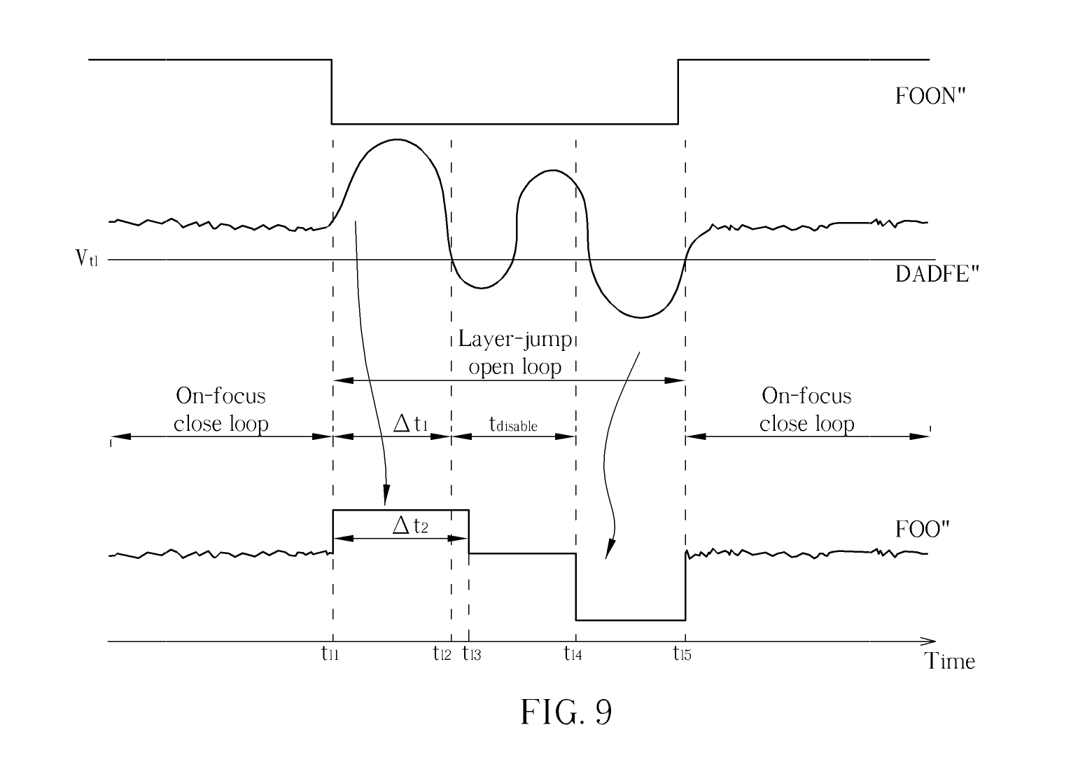

Please refer to FIG. 9. FIG. 9 is a timing diagram illustrating a focus on signal FOON″, the DADFE″ signal, and the focus control signal FOO″ of the servo system 300 as shown in FIG. 8. In order to describe the spirit of the present invention more clearly, the pick-up unit 302 of the servo system 300 of the optical storage device is focused on a low recording layer of an dual-layer optical disc initially, i.e. the on-focus close loop time interval that lies before the time t₁₁, as shown in FIG. 9. When the servo system 300 of the optical storage device receives a jump layer signal to trigger the focus on signal FOON″ to change from a high voltage level into a low voltage level at time t₁₁, the servo system 300 of the optical storage device enters the layer-jump open loop situation at time t₁₁, which means that the pick-up unit 302 will start to jump from the low recording layer to a high recording layer of the dual-layer optical disc at time t₁₁. The focus error signal generating module 304 generates the focus error signal FE″ (i.e. the DADFE″ signal) to the layer detector 3061 after time t₁₁, wherein the focus error signal FE″ is an S-curve signal having a fake signal as shown in FIG. 9. Meanwhile, the focus error signal FE″ is transmitted to the control unit 3062. Furthermore, the focus control signal FOO″ will change to a high voltage level at time t₁₁ to inform the focus actuator 308 to provide a pulling force for the pick-up unit 302. After a time interval Δt₁, in order to avoid the fake signal of the DADFE″ signal being transmitted into the layer detector 3061, the layer detection controller 310 disables the layer detector 3061 to receive the focus error signal FE₁₁ at time t₁₂, and to stop the layer detector 3061 from outputting the control signal S_{c}″ to the control unit 3062 for the predetermined period t_{disable} of time during the layer jump detection. Similar to the above-mentioned embodiments, the focus control signal FOO″ is returned to an average voltage level (i.e., at time t₁₃) after a time interval Δt₂ to inform the focus actuator 308 to turn off the pulling force for the pick-up unit 302. Please note that the time interval Δt₂ can be a predetermined time interval that is set within the control unit 3062. Meanwhile, the pick-up unit 302 keeps moving from the low recording layer to the high recording layer.

After the predetermined period t_{disable}, the layer detection controller 310 enables the layer detector 3061 again at time t₁₄. The layer detector 3061 outputs the control signal S_{c}″ to control the control unit 3062 to change the focus control signal FOO″ to a low voltage level at time t₁₄ for informing the focus actuator 308 to provide a pushing force for the pick-up unit 302, wherein the pushing force is in an opposite direction from the pulling force. The pick-up unit 302 then slows down. Meanwhile, the layer detector 3061 compares the focus error signal FE″ with a low reference voltage Vₜ₁ for detecting the position of the pick-up unit 302. At time t₁₅, the layer detector 3061 detects that the focus error signal FE″ is lower than the low reference voltage Vₜₗ, so the layer detector 3061 outputs the control signal S_{c}″ for the control unit 3062 to change the focus control signal FOO″ to return to the average voltage level for informing the focus actuator 108 to turn off the pushing force for the pick-up unit 102. According to the appropriate setting of the time intervals Δt₁, Δt₂ and the predetermined period t_{disable}, the pick-up unit 102 can be perfectly located at the focusing area of the high recording layer of the dual-layer optical disc as shown in FIG. 6. After time t₄, the focus on signal FOON″ changes from the low voltage level into the high voltage level so the servo system 300 of the optical storage device enters the on-focus close loop situation once more. Please note that the layer detection controller 310 of the present invention is not limited in disabling the layer detector 3061 for the predetermined period t_{disable}, but delaying the layer detector 3061 for the predetermined period t_{disable} to receive the focus error signal FE″ at time t₁₂ also lies within the scope of the present invention.

Therefore, after reading the disclosure of the first embodiment of the present invention, those skilled in this art will readily know that the servo system 300 is capable of retaining the advantage of restraining tracking error coupling upon the DADFE″ signal, but can also overcome the problem of fake signals generated by the DADFE″ signal.

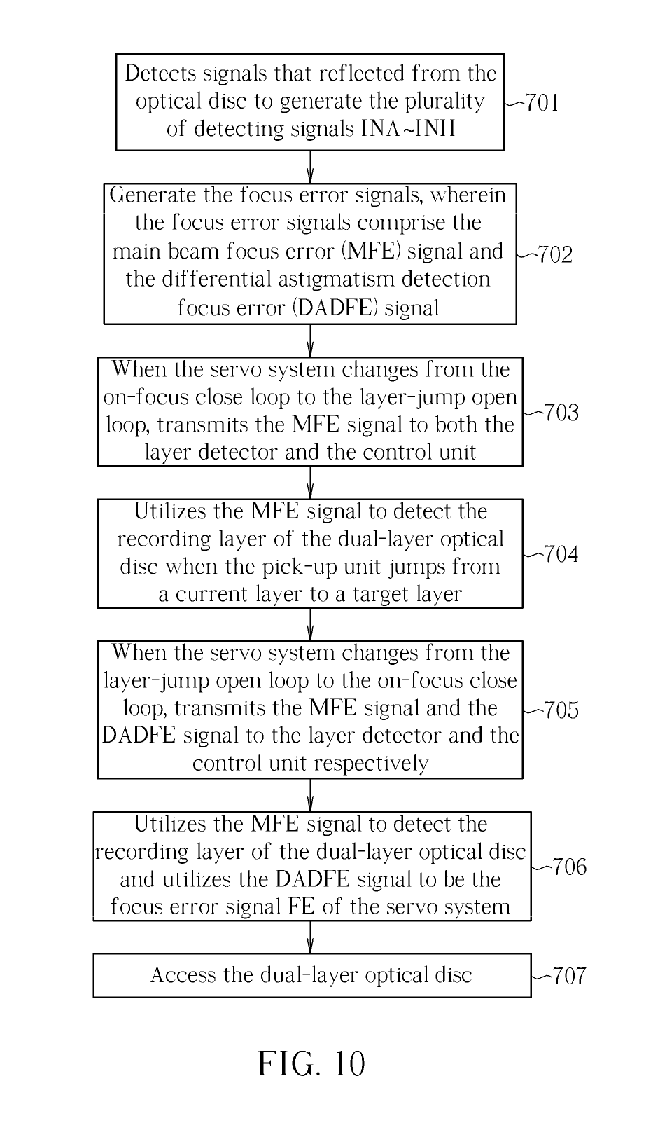

Please refer to FIG. 10. FIG. 10 is a diagram illustrating a servo controlling method of an optical storage device according to a fourth embodiment of the present invention. For brevity, the servo controlling method is applied in the servo system 100 as shown in FIG. 4. The servo controlling method comprises the following steps:
Step 701: Detect signals reflected from the optical disc to generate the plurality of detecting signals INA˜INH;
Step 702: Generate the focus error signals, wherein the focus error signals comprise the main beam focus error (MFE) signal and the differential astigmatism detection focus error (DADFE) signal;
Step 703: When the servo system 100 changes from the on-focus close loop to the layer-jump open loop, transmit the MFE signal to both the layer detector 1061 and the control unit 1062;
Step 704: Utilize the MFE signal to detect the recording layer of the dual-layer optical disc when the pick-up unit 102 jumps from a current layer to a target layer;
Step 705: When the servo system 100 changes from the layer-jump open loop to the on-focus close loop, transmit the MFE signal and the DADFE signal to the layer detector 1061 and the control unit 1062 respectively;
Step 706: Utilize the MFE signal to detect the recording layer of the dual-layer optical disc and utilize the DADFE signal to be the focus error signal FE of the servo system 100;
Step 707: Access the dual-layer optical disc.

Please note that, after reading the disclosure of the above-mentioned fourth embodiment, those skilled in this art are easily to understand the operation between the steps 701˜707 of the servo controlling method, thus further description is omitted here for brevity.

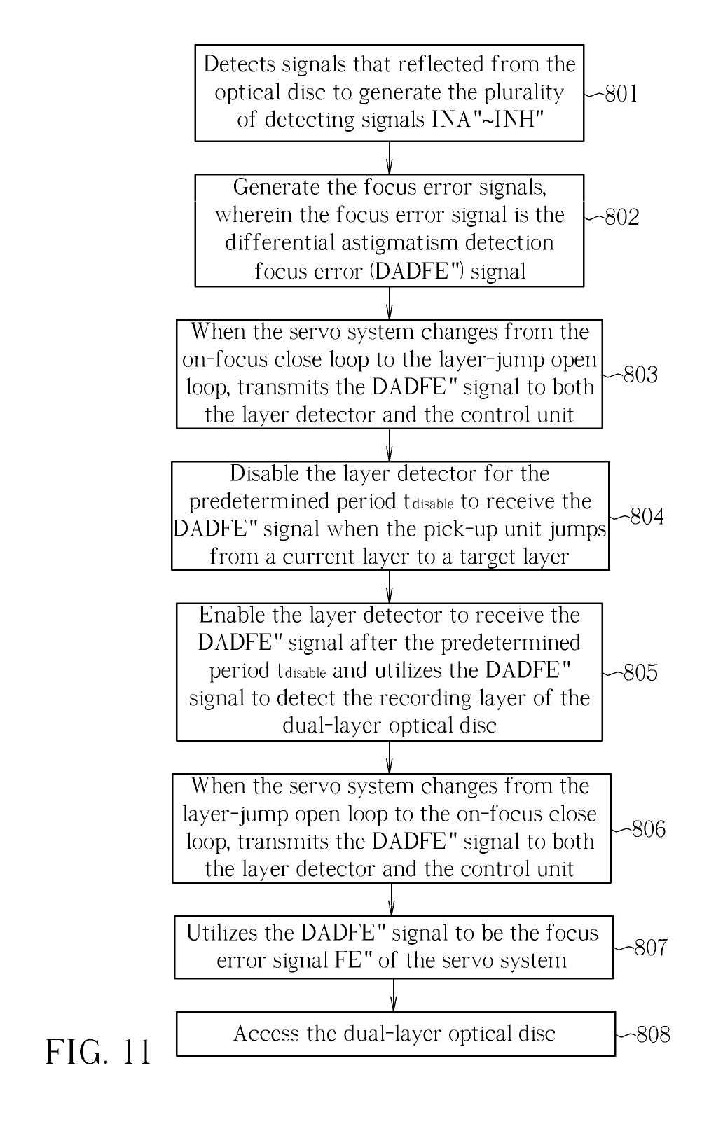

Please refer to FIG. 11. FIG. 11 is a diagram illustrating a servo controlling method of an optical storage device according to a fifth embodiment of the present invention. For brevity, the servo controlling method is applied in the servo system 300 as shown in FIG. 8. The servo controlling method comprises the following steps:
Step 801: Detect signals reflected from the optical disc to generate the plurality of detecting signals INA″˜INH″;
Step 802: Generate the focus error signals, wherein the focus error signal is the differential astigmatism detection focus error (DADFE″) signal;
Step 803: When the servo system 300 changes from the on-focus close loop to the layer-jump open loop, transmit the DADFE″ signal to both the layer detector 3061 and the control unit 3062;
Step 804: Disable the layer detector 3061 for the predetermined period t_{disable} to receive the DADFE″ signal when the pick-up unit 302 jumps from a current layer to a target layer;
Step 805: Enable the layer detector 3061 to receive the DADFE″ signal after the predetermined period t_{disable} and utilize the DADFE″ signal to detect the recording layer of the dual-layer optical disc;
Step 806: When the servo system 300 changes from the layer-jump open loop to the on-focus close loop, transmit the DADFE″ signal to both the layer detector 3061 and the control unit 3062;
Step 807: Utilize the DADFE″ signal to be the focus error signal FE″ of the servo system 300;
Step 808: Access the dual-layer optical disc.

Please note that, after reading the disclosure of the above-mentioned fifth embodiment, those skilled in this art are easily to understand the operation between the steps 801˜808 of the servo controlling method, thus further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A servo system of an optical storage device, the optical storage device comprising an optical pick-up unit for detecting signals reflected from an optical disc to generate a plurality of detecting signals, the servo system comprising:
a focus error signal generating module, coupled to the optical pick-up unit, for generating a plurality of focus error signals according to the detecting signals;
a focus servo control module, coupled to the focus error signal generating module, for receiving focus error signals and generating a focus control signal according to the focus error signals; and
a focus actuator, coupled to the focus servo control module and the optical pick-up unit, for controlling the pick-up unit to adjust a focus position on the optical disc according to the focus control signal.

2. The servo system of claim 1, wherein the focus error signals comprise a main beam focus error (MFE) signal and a differential astigmatism detection focus error (DADFE) signal; and the focus servo control module generates the focus control signal according to the MFE signal and the DADFE signal.

3. The servo system of claim 1, wherein the focus servo control module comprises:
a layer detector, coupled to the focus error signal generating module, for receiving a first focus error signal generated from the focus error signal generating module and detecting a recording layer of the optical disc according to the first focus error signal to generate a control signal; and
a control unit, coupled to the focus error signal generating module, for receiving a second focus error signal generated from the focus error signal generating module and generating the focus control signal according to one of the first focus error signal and the second focus error signal.

4. The servo system of claim 3, wherein the first focus error signal is a main beam focus error (MFE) signal, and the second focus error signal is a differential astigmatism detection focus error (DADFE) signal.

5. The servo system of claim 1, wherein the focus error signal generating module further comprises:
a first focus error signal generator, for generating a first focus error signal according to the detecting signals;
a second focus error signal generator, for generating a second focus error signal according to the detecting signals; and
a switching circuit, coupled to the first focus error signal generator and the second focus error signal generator, for selectively outputting the first focus error signal or the second focus error signal to the focus servo control module.

6. The servo system of claim 5, wherein the focus error signal generating module further comprises:
a level shifter, coupled to at least one of the first focus error signal generator and the second focus error signal generator, for adjusting a voltage level of at least one of the first focus error signal and the second focus error signal when the switching circuit switches between the first focus error signal and the second focus error signal.

7. The servo system of claim 5, wherein the focus servo control module comprises:
a layer detector, coupled to the switching circuit, for receiving an output of the switching circuit and detecting a recording layer of the optical disc according to the output of the switching circuit to generate a control signal; and
a control unit, coupled to the switching circuit, for receiving the output of the switching circuit and generating the focus control signal according to one of the output of the switching circuit and the control signal.

8. The servo system of claim 5, wherein the first focus error signal is a main beam focus error (MFE) signal and the second focus error signal is a differential astigmatism detection focus error (DADFE).

9. A servo system of an optical storage device, the optical storage device comprising a pick-up unit for detecting signals reflected from an optical disc to generate a plurality of detecting signals, the servo system comprising:
a focus error signal generating module, coupled to the pick-up unit, for generating a focus error signal according to the detecting signals;
a layer detector, coupled to the focus error signal generating module, for detecting a layer of the optical disc and generating a control signal according to the focus error signal;
a control unit, coupled to the layer detector and the focus error signal generating module, for receiving the focus error signal and generating a focus control signal according to one of the focus error signal and the control signal;
a layer detection controller, coupled to the layer detector, for stopping the layer detector from outputting the control signal to the control unit for a predetermined period of time during a layer jump detection; and
a focus actuator, coupled to the control unit and the pick-up unit, for controlling the pick-up unit to adjust a focus position on the optical disc according to the focus control signal.

10. The servo system of claim 9, wherein during the layer detection operation, the layer detection controller disables the layer detector for the predetermined period of time to stop the layer detector from outputting the control signal to the control unit.

11. A servo controlling method of an optical storage device, the optical storage device comprising a pick-up unit for detecting signals reflected from an optical disc to generate a plurality of detecting signals, the servo controlling method comprising:
(a) generating a plurality of focus error signals according to the detecting signals;
(b) generating a focus control signal according to the focus error signals; and
(c) controlling the pick-up unit to adjust a focus position on the optical disc according to the focus control signal.

12. The servo controlling method of claim 11, wherein the focus error signals comprises a main beam focus error (MFE) signal and a differential astigmatism detection focus error (DADFE) signal; and the focus control signal is generated according to the MFE signal and the DADFE signal.

13. The servo controlling method of claim 11, wherein step (b) comprises:
receiving a first focus error signal generated from step (a) and detecting a recording layer of the optical disc according to the first focus error signal to generate a control signal; and
receiving a second focus error signal generated from step (a) and generating the focus control signal according to one of the first focus error signal and the second focus error signal.

14. The servo controlling method of claim 13, wherein the first focus error signal is a main beam focus error (MFE) signal, and the second focus error signal is a differential astigmatism detection focus error (DADFE) signal.

15. The servo controlling method of claim 11, wherein step (a) further comprises:
generating a first focus error signal according to the detecting signals;
generating a second focus error signal according to the detecting signals; and
utilizing a switching circuit to selectively output the first focus error signal or the second focus error signal.

16. The servo controlling method of claim 15, wherein step (a) further comprises:
adjusting a voltage level of at least one of the first focus error signal and the second focus error signal when the switching circuit switches between the first focus error signal and the second focus error signal.

17. The servo controlling method of claim 15, wherein step (b) comprises:
receiving an output of the switching circuit and detecting a recording layer of the optical disc according to the output of the switching circuit to generate a control signal; and
receiving the output of the switching circuit and generating the focus control signal according to one of the output of the switching circuit and the control signal.

18. The servo controlling method of claim 15, wherein the first focus error signal is a main beam focus error (MFE) signal and the second focus error signal is a differential astigmatism detection focus error (DADFE).

19. A servo controlling method of an optical storage device, the optical storage device comprising a pick-up unit for detecting signals reflected from an optical disc to generate a plurality of detecting signals, the servo controlling method comprising:
generating a focus error signal according to the detecting signals;
detecting a layer of the optical disc and generating a control signal according to the focus error signal;
providing a control unit to receive the focus error signal and generating a focus control signal according to one of the focus error signal and the control signal;
utilizing a layer detection controller to stop the layer detector from outputting the control signal to the control unit for a predetermined period of time during a layer jump detection; and
controlling the pick-up unit to adjust a focus position on the optical disc according to the focus control signal.

20. The servo controlling method of claim 19, wherein during the step of layer detection operation, the layer detection controller disables the layer detector for the predetermined period of time to stop the layer detector from outputting the control signal to the control unit.
